(19) United States
(12) Patent Application Publication
(10) Pub. No.: US 2012/0133070 A1
(43) Pub. Date: May 31, 2012

(54) SAFETY STUFFED TOY AND METHOD FOR PRODUCING THE SAME

(76) Inventor: Chih-Cheng LAI, Taipei (TW)

(21) Appl. No.: 13/369,034

(22) Filed: Feb. 8, 2012

Related U.S. Application Data
(62) Division of application No. 12/715,611, filed on Mar. 2, 2010.

(51) Int. Cl. B29C 67/20

(52) U.S. Cl. 264/46.6

(57) ABSTRACT

A safety stuffed toy has a latex body formed to define an exterior appearance and having a chamber therein, and a PU stuffing formed by polyurethane foam, fully filled in the chamber and adhered to an inner wall of the latex body. A method for producing a safety stuffed toy has a mold preparing step, a latex injecting step, a polyurethane filling step, a foaming step and a demolding step. As the PU stuffing is securely bonded to the latex body and won't be easily fragmented, the present invention is advantageous in providing a safer stuffed toy. Besides, the foaming process of the polyurethane foam material spontaneously and extensively spreads the polyurethane foam material inside the chamber of body to facilitate stuffing the body effectively.

The present invention is a divisional application of the application Ser. No. 12/715,611, filed on Mar. 2, 2010.

### BACKGROUND OF THE INVENTION

1. Field of the Invention

The present invention is related to a stuffed toy, and more particularly to a safety stuffed toy having a latex body and a polyurethane stuffing filled in the latex body and a method of producing the safety stuffed toy.

2. Description of the Related Art

Stuffed toys are soft throughout, resilient and squeezable and can be used as toys for pets to play with and chew.

With reference to FIG. 4, a conventional stuffed toy has a resilient body (41) and a core (42). The resilient body (41) is formed by latex and the core (42) is formed by artificial cotton fibers. The stuffed toy has an embedded whistle (43). When pressed or released, air is forced through the embedded whistle (43) so making a squeaking sound. The cuddly, chewable and audible stuffed toys attract pets. However, when the resilient body (41) is subjected to excessive wear and damage, cracks and holes may appear on the resilient body (41) and the artificial cotton fibers fall out of the resilient body (41) and are scattered around. Scattered fibers require cleaning Accordingly, the conventional stuffed toy requires further refinement.

### SUMMARY OF THE INVENTION

An objective of the present invention is to provide a method for producing safety stuffed toy by filling a PU material having low toxicity and that is not easily fragmented in a body.

To achieve the foregoing objective, the method for producing a safety stuffed toy has steps of:

preparing a mold for generating a latex body of a safety stuffed toy;

injecting molten latex into the mold to form the latex body having a chamber therein and an orifice thereon;

filling the chamber of the latex body with a polyurethane foam material through the orifice after the latex body has cooled;

performing a foaming process of the polyurethane foam material until the polyurethane foam material is fully foamed inside the chamber and adhered to an inner wall of the latex body; and

removing the mold from the latex body.

Since the PU stuffing is securely bonded to the inside of the latex body and, unlike artificial cotton fiber, PU stuffing does not easily fragment, PU fragments are not spread around or inhaled or eaten by people or animals. Besides, polyurethane (PU) is a polymer with low toxicity. All these qualities make the safety stuffed toy of the present invention a safer stuffed toy than conventional stuffed toys. In addition, the foaming process in the method of producing a safety stuffed toy spontaneously and extensively spreads the polyurethane foam material inside the chamber of the body to facilitate stuffing the body effectively.

### BRIEF DESCRIPTION OF THE DRAWINGS

FIG. 1 is a perspective view of a safety stuffed toy in accordance with the present invention;

FIG. 2 is a partially cross-sectional view of the safety stuffed toy in FIG. 1;

FIG. 3 is a flow diagram of a method for producing a safety stuffed toy in accordance with the present invention; and

FIG. 4 is a partially cross-sectional view of a conventional stuffed toy.

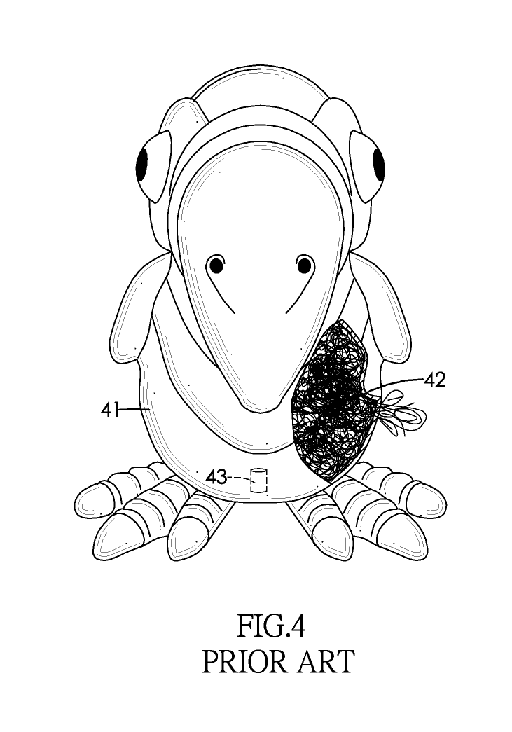

### DETAILED DESCRIPTION OF THE INVENTION

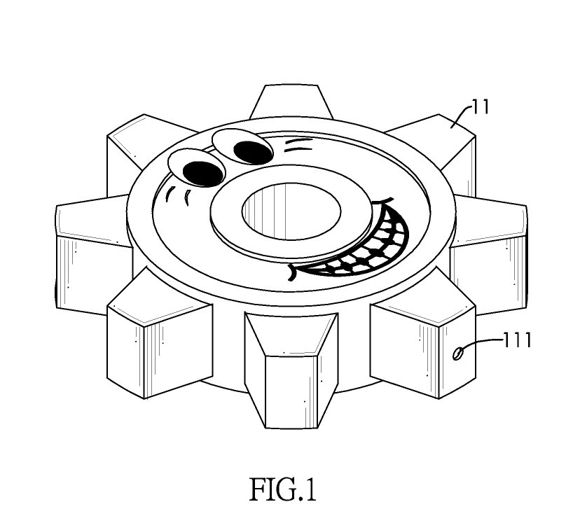

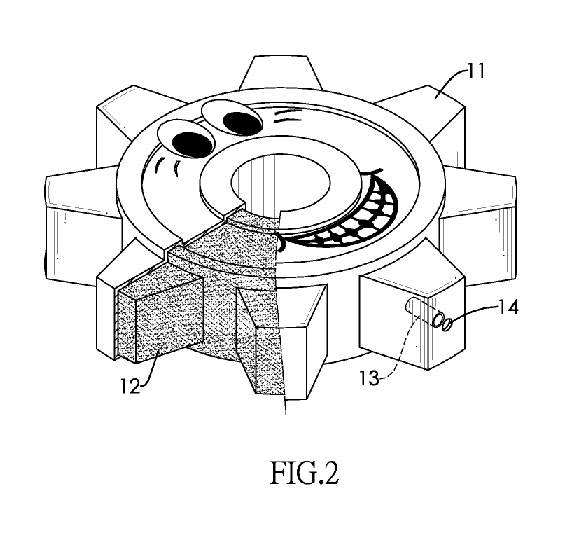

With reference to FIGS. 1 and 2, a safety stuffed toy in accordance with the present invention has a latex body (11), a polyurethane (PU) stuffing (12), an orifice (13) and a whistle (14).

The latex body (11) is formed to define an exterior appearance and has a chamber therein. Depending upon entertaining effect, the latex body (11) may be formed as an animal, novelty shape, such as a ball, a vegetable, food or the like. The latex body (11) in FIG. 1 is formed as a gear. Due to the nature of being soft and resilient, latex is commonly used as a material to generate a harmless exterior part. The PU stuffing (12) is formed by a polyurethane foam material through a foaming process in the chamber and is adhered to an inner wall of the latex body (11). As the PU stuffing (12) is soft and resilient together with the soft and resilient nature of the latex body (11), the whole safety stuffed toy is also soft and resilient from inside out. As the PU stuffing (12) formed in the foaming process completely fills the chamber and is also adhered to an inner wall of the latex body (11), the latex body (11) and the PU stuffing (12) are securely bonded. The orifice (13) is formed through the latex body (11). The polyurethane foam material is injected through the orifice (13) into the chamber. The whistle (14) is mounted inside the chamber to align with the orifice (13). When squeezed, air inside the safety stuffed toy is blown through the whistle (14) and the orifice (13) to produce a sound.

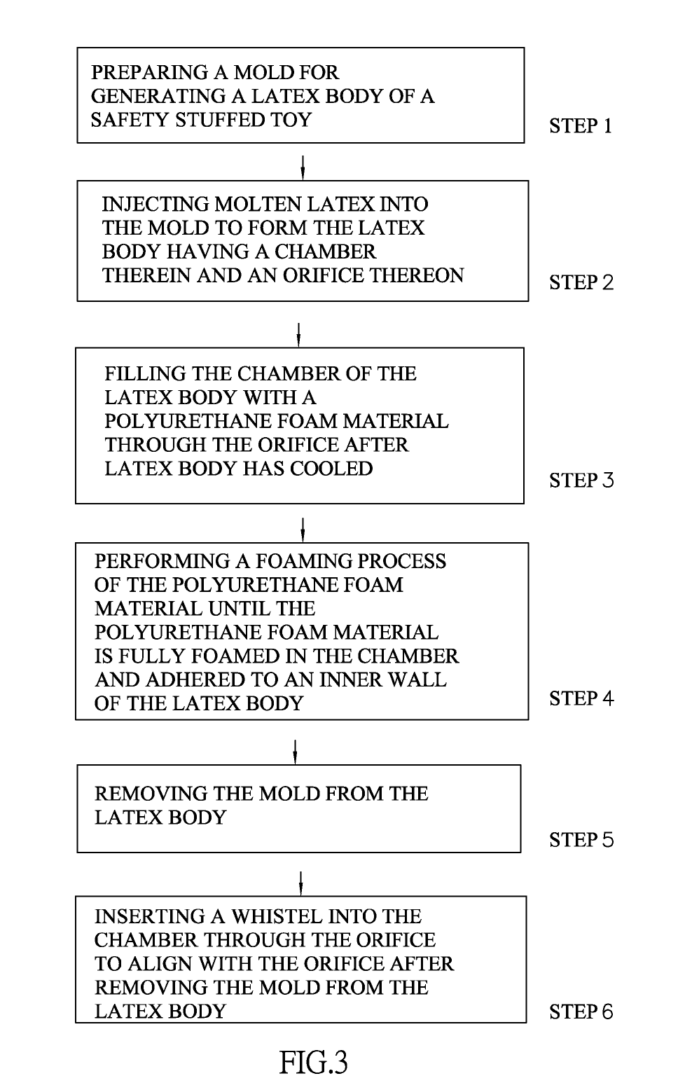

Furthermore, with reference to FIG. 3, a method for producing a safety stuffed toy in accordance with the present invention has steps of:

STEP 1: preparing a mold for generating a latex body of a safety stuffed toy;

STEP 2: injecting molten latex into the mold to form the latex body having a chamber therein and an orifice thereon;

STEP 3: filling the chamber of the latex body with a polyurethane foam material through the orifice after the latex body has cooled;

STEP 4: performing a foaming process of the polyurethane foam material until the polyurethane foam material is fully foamed in the chamber and adhered to an inner wall of the latex body;

STEP 5: removing the mold from the latex body; and

STEP 6: inserting a whistle into the chamber through the orifice to align with the orifice after removing the mold from the latex body.

As far as the safety stuffed toy of the present invention is concerned, the soft and resilient nature of the latex body (11) and the PU stuffing (12) certainly won't give rise to harmful effect if chewed or and played with. Furthermore, as the PU stuffing (12) is adhered to the latex body (11), unlike the artificial cotton fiber, the PU stuffing (12) won't be easily fragment into small pieces that would be spread around and inhaled or eaten by people or animals In addition to being cushioning, anti-abrasive, dampening and flexible, polyurethane is a polymer with low toxicity. As a consequence, the safety stuffed toy of the present invention has better safety than conventional stuffed toy when chewed or played with. As to the method for producing a safety stuffed toy, the foaming process of the polyurethane foam material spontaneously and extensively spreading the polyurethane foam material inside the chamber of body facilitates the stuffing inside the body in an effective way.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for producing a safety stuffed toy, comprising steps of:
preparing a mold for generating a latex body of a safety stuffed toy;
injecting molten latex into the mold to form the latex body having a chamber therein and an orifice thereon;
filling the chamber of the latex body with a polyurethane foam material through the orifice after the latex body is cooled down;
performing a foaming process of the polyurethane foam material until the polyurethane foam material is fully foamed inside the chamber and adhered to an inner wall of the latex body; and
removing the mold from the latex body.

2. The method for producing a safety stuffed toy as claimed in claim 1 further comprising a step of:
inserting a whistle into the chamber through the orifice to align with the orifice after the step of removing the mold from the latex body.
